(19) United States
(12) Patent Application Publication
(10) Pub. No.: US 2016/0221281 A1
(43) Pub. Date: Aug. 4, 2016

(54) LENS MODIFICATION METHODS

(71) Applicant: BATTELLE MEMORIAL INSTITUTE, Columbus, OH (US)

(72) Inventor: John S. Laudo, Hilliard, OH (US)

(21) Appl. No.: 15/021,659

(22) PCT Filed: Sep. 10, 2014
(86) PCT No.: PCT/US2014/054958

§ 371 Date: Mar. 11, 2016

Related U.S. Application Data
(60) Provisional application No. 61/877,016, filed on Sep. 12, 2013.

(51) Int. Cl. B29D 11/00; G02C 7/10; G02C 7/04

(52) U.S. Cl. CPC B29D 11/00038; G02C 7/04; G02C 7/108; G02C 7/046; G02C 2202/16

(57) ABSTRACT

A method of adjusting the optical power of a lens includes individually exposing an interior volume within the lens to radiation to form at least one interior surface within the lens. The at least one interior surface alters the refractive index of the lens, thereby adjusting the power of the lens.

### CROSS-REFERENCE TO RELATED APPLICATION

This application claims priority to U.S. Provisional Patent Application Ser. No. 61/877,016, filed on Sep. 12, 2013. That application is hereby fully incorporated by reference herein.

### BACKGROUND

The present disclosure relates to methods and devices that are useful for adjusting the optical power of a lens. Such optical lenses may include lenses in eyewear that are exterior to the eye and ophthalmic lenses that are used in close proximity to the eye.

The eye can suffer from several different defects that affect vision. Common defects include myopia (i.e. nearsightedness) and hyperopia (i.e. farsightedness). These types of defects occur when light does not focus directly on the retina, and can be corrected by the use of corrective lenses, such as eyeglasses or contact lenses.

In particular, the lens of the eye is used to focus light on the retina. The lens is usually clear, but can become opaque (i.e. develop a cataract) due to age or certain diseases. The usual treatment in this case is to surgically remove the opaque lens and replace it with an artificial or intraocular lens.

It can be desirable to be able to adjust such lenses, either before they are provided to a user or afterwards. In the case of eyeglasses and/or contact lenses, this permits the economical manufacture of lenses which can then be custom-fitted or adjusted to correct manufacturing defects. Such adjustments can also be useful in correcting misplacement of an intraocular lens during the surgical operation and/or to treat higher order optical aberrations. A common method is to use ultraviolet (UV) activation to induce the change in lens performance, to allow for high spatial resolution of the adjustment (due to the low wavelength of UV). After the lens is adjusted, the lens should not appreciably change in performance over the lifetime of the lens.

U.S. Pat. No. 7,134,755 describes a lens that uses ultraviolet light curable monomers in a silicone polymer matrix. The monomers are selectively polymerized using a digital light delivery system to alter the lens power at specific points.

There are two distinct effects that alter the lens optical power in this system. First, the polymerization of the UV curable monomers changes the refractive index of the system from n=1.4144 to n=1.4229, which would increase the optical power of the test lens from 95.1 diopters to 96.7 diopters. This change in the lens power is much smaller than the change in lens power that was reported in the patent, indicating this is not the primary mechanism of index change in this patent.

The second effect, which is responsible for the largest component of the change in lens optical power, is a swelling of the lens in the irradiated region. This swelling effect is illustrated in FIG. 1.

In FIG. 1A, free monomers (denoted M) are present in a silicone polymer matrix 10. In FIG. 1B, a mask 20 is used to expose only a portion 30 of the lens to UV radiation. The monomers in the region exposed to the UV radiation undergo polymerization, forming polymers P and slightly changing the refractive index. Over time, as seen in FIG. 1C, monomers from the un-exposed regions 40, 50 then migrate into the exposed region 30, causing that region to swell. This change in the lens thickness then leads to a larger change in the optical power. In FIG. 1D, after the migration of the monomer is finished, the whole lens is then exposed to UV radiation to freeze the changes.

There are several shortcomings to this method. One is that the primary change in the lens optical power is due to diffusion of monomer, which is a relatively slow process. Another shortcoming is that the dependence on diffusion as the operative effect limits the spatial resolution of the changes in the lens optical power. A third shortcoming is that the increase in lens thickness in the exposed region forces a thickness decrease in adjacent regions, as monomer from the adjacent region diffuses into the exposed region. This change in thickness in the adjacent regions is not easily controllable. Lenses without these shortcomings and others are desirable.

### BRIEF DESCRIPTION

Disclosed in various embodiments are devices and methods for adjusting the optical power of a lens.

These and other non-limiting aspects and/or objects of the disclosure are more particularly described below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following is a brief description of the drawings, which are presented for the purposes of illustrating the disclosure set forth herein and not for the purposes of limiting the same.

FIGS. 1A-1D are illustrations of a conventional method for adjusting lens optical power.

FIG. 2 is a graph showing a normalized change in lens optical power as a function of the refractive index of the lens in both air and water.

FIG. 3A is a front view of an original lens prior to being modified with the methods of the present disclosure.

FIG. 3B is a side cutaway view of the lens of FIG. 3A.

FIG. 4A is a front view of a first embodiment of a lens that has been modified with the methods of the present disclosure. Here, the interior surface is formed to increase the overall refractive index of the lens.

FIG. 4B is a side cutaway view of the lens of FIG. 4A.

FIG. 5 is a side cutaway view of a second embodiment of a lens that has been modified with the methods of the present disclosure. Here, the interior surface is formed to decrease the overall refractive index of the lens.

FIG. 6 is a side cutaway view of a third embodiment of a lens that has been modified with the methods of the present disclosure. Multiple interior surfaces are present.

FIG. 7 is a perspective view of an apparatus that may be used to perform the methods of the present disclosure.

FIG. 8 is a magnified view showing the lens located within the apparatus of FIG. 7.

FIG. 9 is a side cutaway view of a computer modeled lens.

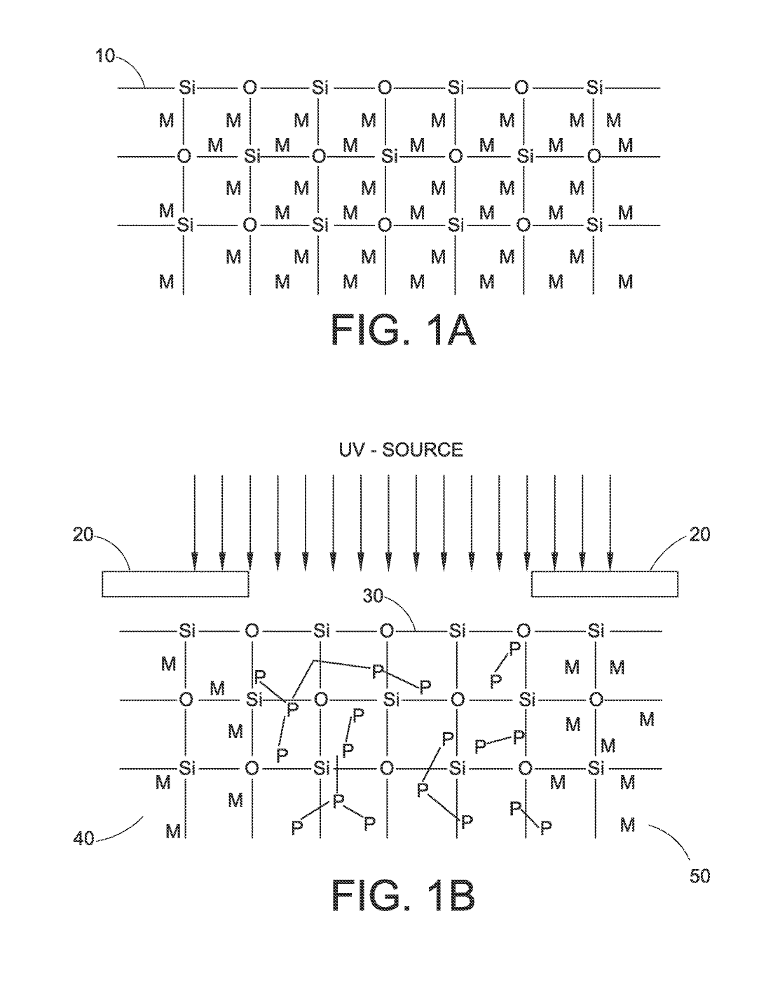

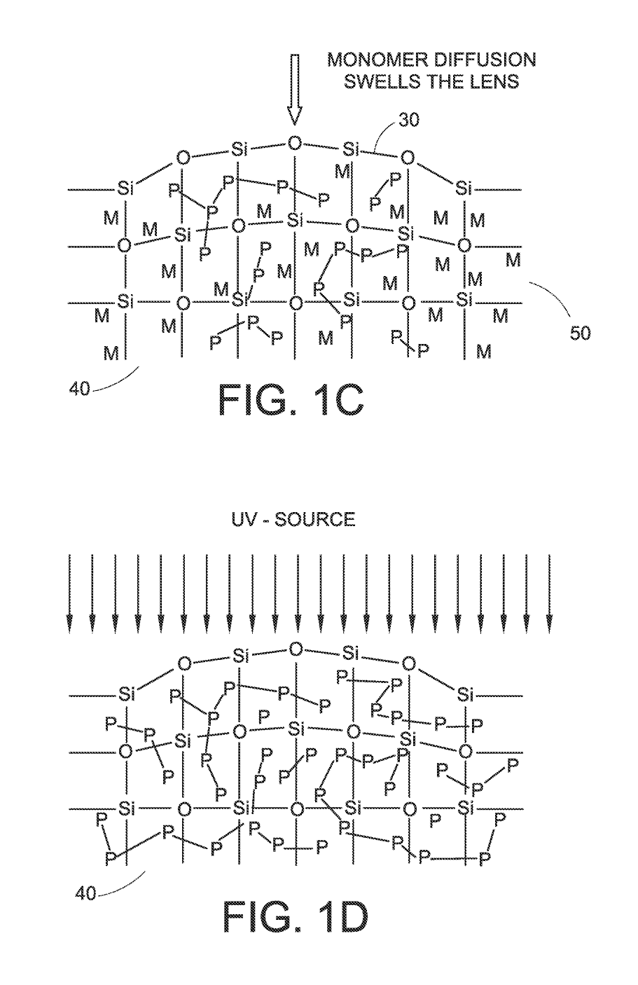

### DETAILED DESCRIPTION

A more complete understanding of the processes and apparatuses disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used with a specific value, it should also be considered as disclosing that value. For example, the term “about 2” also discloses the value “2” and the term “from about 2 to about 4” also discloses the range “from 2 to 4.”

References to ultraviolet or UV radiation should be understood as referring to the portion of the light spectrum having wavelengths between about 400 nm and about 10 nm.

The “refractive index” of a medium is the ratio of the speed of light in a vacuum to the speed of light in the medium. For example, the refractive index of a material in which light travels at two-thirds the speed of light in a vacuum is (1/(2/3))=1.5.

The term “chromophore” refers to a chemical moiety or molecule that has a substantial amount of aromaticity or conjugation. This aromaticity or conjugation increases the absorption strength of the molecule and to push the absorption maximum to longer wavelengths than is typical for molecules that only have sigma bonds. In many cases this chromophore will act to impart color to a material. As defined here, the chromophore does not need to absorb in the visible (i.e. does not need to be colored), but can have its absorption maximum in the UV. Alternately, the chromophore could have absorption maximum in the near-IR, with no significant absorption in the visible wavelength range. The chromophore will have refractive index larger than that of the base polymer.

Non-limiting examples of chromophores which act to impart color to a material include C.I. Solvent Blue 101; C.I. Reactive Blue 246; C.I. Pigment Violet 23; C.I. Vat Orange 1; C.I. Vat Brown 1; C.I. Vat Yellow 3; C.I. Vat Blue 6; C.I. Vat Green 1; C.I. Solvent Yellow 18; C.I. Vat Orange 5; C.I. Pigment Green 7; D&C Green No. 6; D&C Red No. 17; D&C Yellow No. 10; C.I. Reactive Black 5; C.I. Reactive Blue 21; C.I. Reactive Orange 78; C.I. Reactive Yellow 15; C.I. Reactive Blue 19; C.I. Reactive Blue 4; C.I. Reactive Red 11; C.I. Reactive Yellow 86; C.I. Reactive Blue 163; and C.I. Reactive Red 180.

Additional molecules which could act as a chromophore for this disclosure, but will not impart color to a material, include derivatives of oxanilides, benzophenones, benzotriazoles and hydroxyphenyltriazines. Other examples can be found in Dexter, “UV Stabilizers”, Kirk-Othmer Encyclopedia of Chemical Technology 23: 615-627 (3d. ed. 1983), U.S. Pat. No. 6,244,707, and U.S. Pat. No. 4,719,248. The disclosures of these documents are incorporated by reference herein.

Other molecules which can act as chromophores for this disclosure include unsaturated molecules found in nature, such as riboflavin, lutein, b-carotene, cryptoxanthin, zeaxanthin, or Vitamin A, as examples.

The term “photobleaching” refers to a change in the chromophore induced by photochemical means. Exemplary changes may be the cleavage of the chromophore into two or more fragments, or a change in the bond order of one or more covalent bonds in the chromophore, or a rearrangement of the bonds, such as a transition from a trans-bonding pattern to a cis-bonding pattern. Alternately, the change could be the cleavage of a bond such that the chromophore is no longer covalently bound to the polymer matrix, allowing the chromopohore to be removed during wash steps.

The term “optical lens” is used herein to refer to a device through which vision can be modified or corrected, or through which the eye can be cosmetically enhanced (e.g. by changing the color of the iris) without impeding vision. Non-limiting examples of optical lenses include eyewear and ophthalmic lenses. The term “ophthalmic lenses” refers to those devices that contact the eye. Examples of ophthalmic lenses include contact lenses and intraocular lenses. Examples of eyewear include glasses, goggles, full face respirators, welding masks, splash shields, and helmet visors.

The optical power of a simple lens is given by the following Equation 1:

$$\frac{1}{f} = ( n - {n}_{0} ) [ \frac{1}{{R}_{1}} - \frac{1}{{R}_{2}} + \frac{( n - {n}_{0} ) d}{{nR}_{1} {R}_{2}} ] \qquad ( 1 )$$

where 1/f is the optical power of the lens (measured in diopters or m⁻¹), n is the refractive index of the lens material, n₀ is the refractive index of the surrounding medium, R₁ and R₂ are the two radii of curvature of the lens, and d is the thickness of the lens.

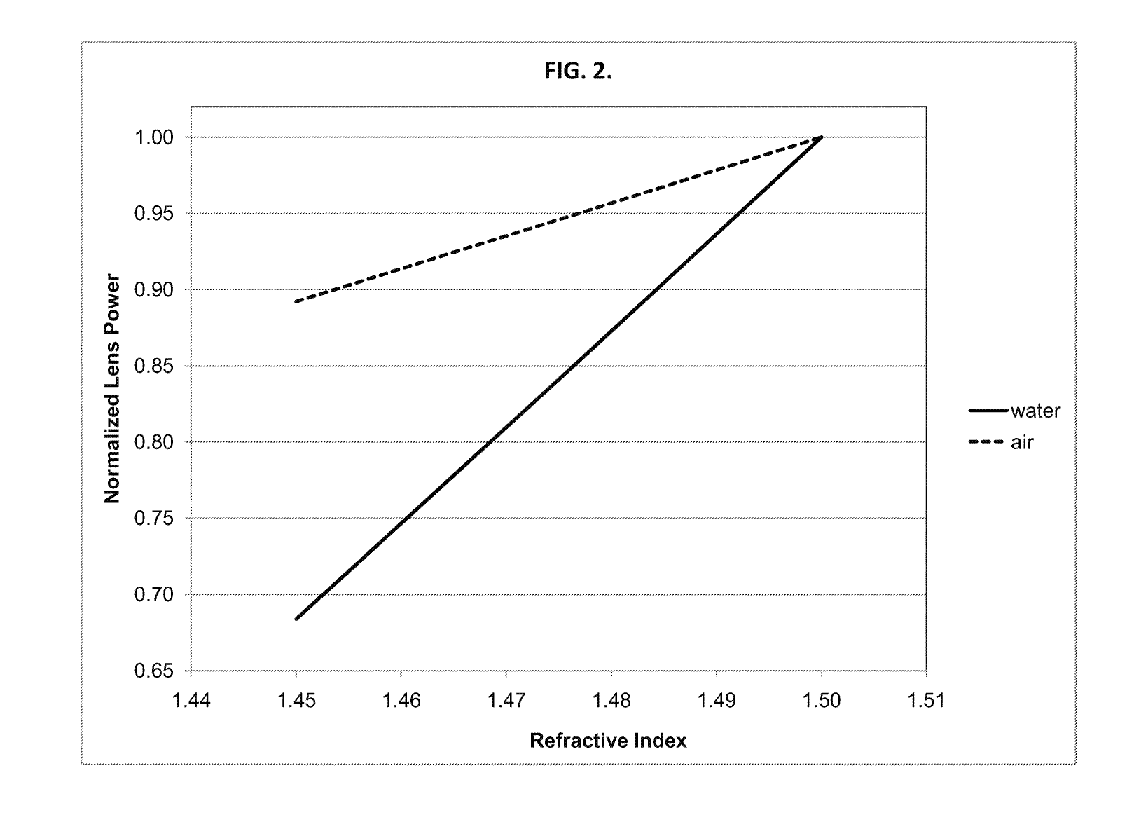

The importance of change in the refractive index is shown in FIG. 2, which is a graph showing the normalized change in lens optical power as a function of the refractive index for a lens placed both in water and air (normalized by the lens power at n=1.5). The calculations were performed using R₁=0.00185 m, R₂=0.00255 m, d=300 μm, n₀ for water=1.3374, and n₀ for air=1.0000.

In the methods of the present disclosure, the optical power (i.e. effective focal length) of the lens can be adjusted by changing the overall refractive index, but not the shape, of the lens. This is accomplished by creating at least one interior surface within or inside the lens. Thus, one is able to modify the optical power of the lens, or to correct any aberrations. To do so, one or more microvolumes within the lens are individually exposed to radiation. Depending on how the interior surface(s) are constructed, the optical power can be increased or decreased. Each interior surface can be a refractive surface or a diffractive surface within the lens. The methods could also be considered as creating one or more microlenses within the original lens, with those microlenses changing the overall refractive index of the lens. It should be noted that these methods are suitable for spherical lenses, aspherical lenses, toric lenses, etc.

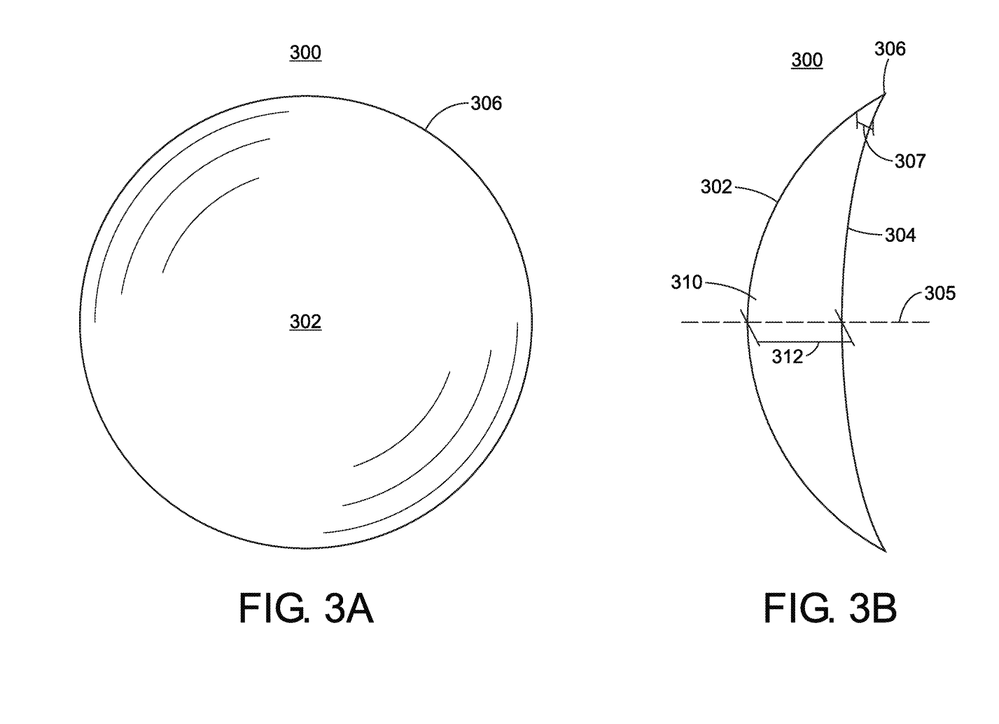

Initially, FIG. 3A is a front view of a lens, which is a contact lens, prior to using the methods of the present disclosure. FIG. 3B is a side cross-sectional view of the lens of FIG. 3A.

The lens 300 has an anterior surface 302 and a posterior surface 304. These two surfaces meet at the edge 306 of the lens. The center 310 of the lens has a center thickness 312. This center thickness is measured along the longitudinal axis 305. The edge 306 of the lens has an edge thickness 307. As is evident, the center of the lens is thicker than the edge of the lens. In embodiments, the center thickness may be from 0.03 mm to 0.8 mm. The edge thickness may be from 0.05 mm to 0.15 mm. The lens is homogeneous, or in other words all portions throughout the internal volume have the same refractive index. The diameter of the lens may be from 8 mm to 15 mm.

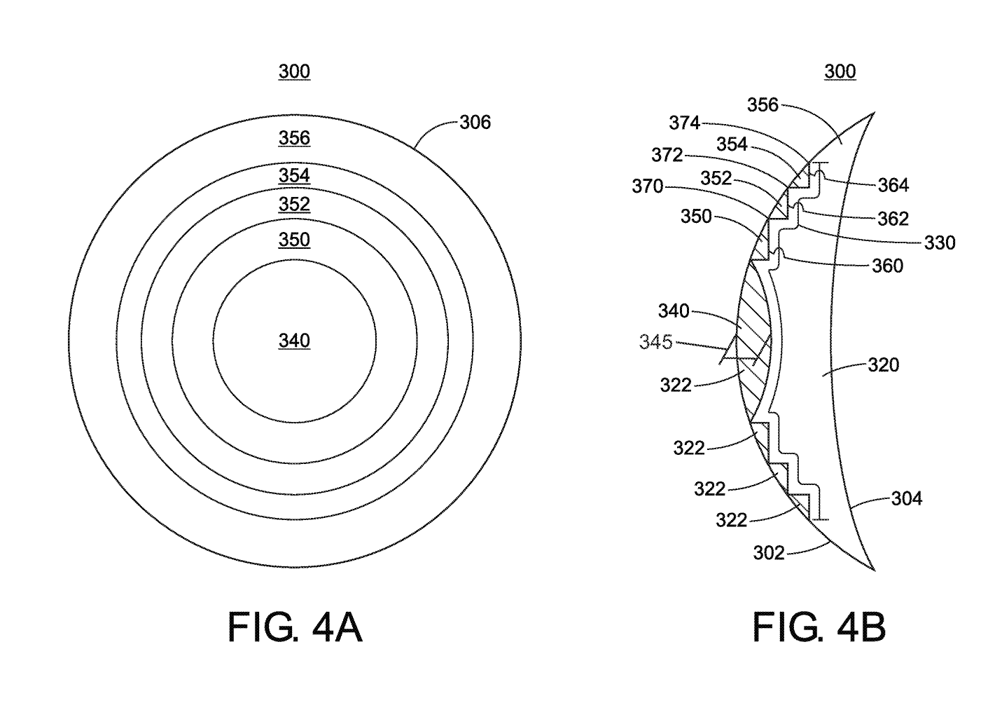

FIG. 4A is a front view of an exemplary lens after the methods of the present disclosure have been performed. FIG. 4B is a side cross-sectional view of the lens of FIG. 4A. Several microvolumes (i.e. voxels) of the lens have been exposed to radiation. The internal or interior volume of the lens of FIG. 3A can now be considered to be divided into an exposed volume 320 and a non-exposed volume 322. The exposed volume can be considered to be a microlens within the original lens. The refractive index of the original lens is maintained in the non-exposed volume 322, while the refractive index of the exposed volume(s) 320 is altered. In this particular example, the overall refractive index is increased compared to the original lens.

As a result of that exposure, one or more interior surfaces 330 have been formed or created within the lens. Here, the exposed volume is in the form of a central disk 340 and four sequential rings 350, 352, 354, 356 around the central disk. Three of the rings 350, 352, 354 are made from the non-exposed relatively higher refractive material of the original lens, while the fourth ring 356 is relatively low refractive index created by exposure to radiation. The interior surface 330 is visible here as the interface between the exposed volume 320 and the non-exposed volume 322. This particular interior surface is formed from the combination of the surfaces of the central disk and the rings.

Here, the central disk 340 of the lens has the form of a biconvex lens. The portions of the lens adjacent to the anterior surface 302 are unmodified, relatively higher refractive index portions, while the portions adjacent the posterior surface 304 represent the modified, relatively lower refractive index portions. Each ring will have a unique mathematical shape, and is generally not a flat section. The biconvex lens is maximized to fit its diameter 345 within the thickness allowance 312 of the overall lens. The radius of curvature of the biconvex portion can be selected based on the desired power change for the overall lens. The number of rings will depend upon the thickness of the lens, the power correction desired, and the tolerance for aberrations or amount of correction required.

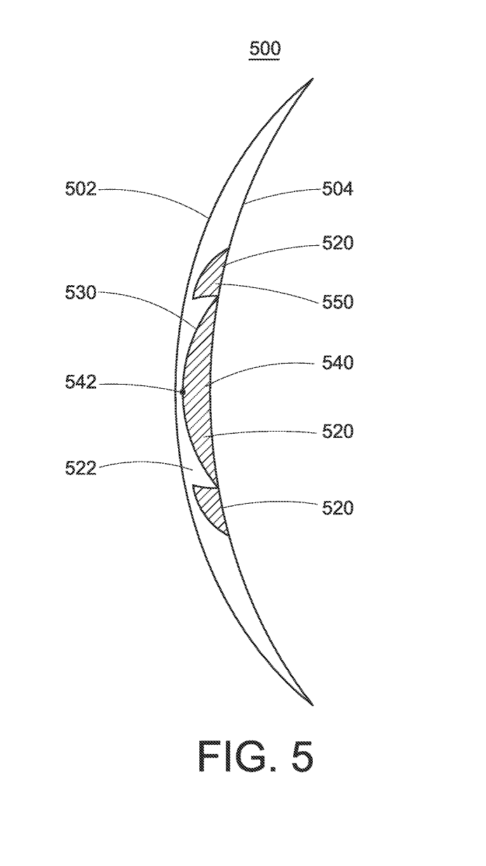

FIG. 5 is a side cross-sectional view of a second exemplary embodiment of a lens 500. Again, the lens has an anterior surface 502 and a posterior surface 504. This embodiment includes a central disk 540 and a single ring 550, although additional rings may be included. Again, the exposed volume 520 adjacent the posterior surface 504 has a lower refractive index compared to the non-exposed volume 522 of the lens adjacent the anterior surface. An interior surface 530 is present at the interface. In this embodiment, the optical power of the lens is reduced. This embodiment differs from FIG. 4B in the shape and location of the central disk 540.

Generally, the central disk 540 has a vertex 542 which is closer to the anterior surface 502 to reduce the optical power, or the vertex is closer to the posterior surface 504 to increase the optical power. Again, it is usually desirable to maximize the diameter of the central disk, to minimize the number of refractive index changes in the design of the lens and minimize diffraction within the lens. Moving the vertex permits the diameter of the central disk to be maximized.

For example, with a starting lens having a refractive index of 1.4, a posterior surface with a radius of curvature of −8.45 mm, and an anterior surface with a radius of curvature of −8.985 mm, a negative 1 diopter change may be achieved by forming a central disk having a diameter of 2.9 mm with a −5.7 mm radius of curvature and a refractive index of 1.385.

The central disk (having a changed reflective index) may have a diameter of from about 2 mm to about 4 mm. The thickness 345 of the central disk (see FIG. 4B) is less than the center thickness 312 of the lens, and may be from 0.01 mm to 0.7 mm.

The sequential rings surrounding the central disk are used to refract light towards the central focal point. In this regard, the lens is generally designed to have only one focal point. Lenses with multiple focal points have been made and tested in human patients, but such lenses exhibited glare effects that were noticeable to patients and undesired. In some embodiments, the lenses of the present disclosure are designed to suppress multiple focal point or energy diffracted into higher orders of the lens in order to reduce the amount of stray light present.

Diffraction occurs strongly as the dimensional scales of the rings approach the wavelength of visible light. The design of the lens should take this into account, so that performance can be optimized to include coherent effects and minimize stray light that can cause unwanted glare or halo effects.

In certain embodiments of FIG. 4B and FIG. 5, the sequential rings are designed to maximize their radial extent. Put another way, as illustrated in FIG. 4B, the rings 350, 352, 354 can be considered to have an internal surface 360, 362, 364 within the lens. This internal surface of the ring terminates adjacent the anterior surface 302 of the lens (at points 370, 372, 374). This minimizes diffractive edges in the system which could cause stray light. This also maximizes the dimensions of the internal surface(s) in the lens, which in turn reduces the influence of fabrication errors.

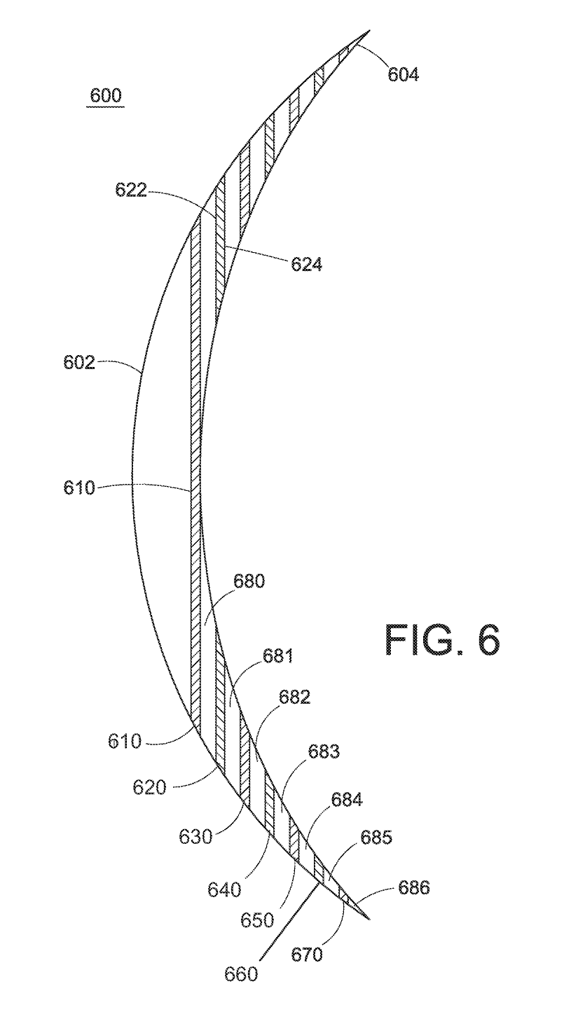

FIG. 6 shows an embodiment in which multiple interior surfaces are formed. This embodiment of a lens 600 has an anterior surface 602 and a posterior surface 604. Within the lens are a central disk 610 and six rings 620, 630, 640, 650, 660, 670. The central disk and six rings were modified by exposure to radiation. The central disk and the six rings are separated by relatively higher refractive index portions 680, 681, 682, 683, 684, 685, 686 which are the original lens (i.e. non-exposed). Each ring has two internal surfaces, a front surface and a rear surface, which terminate adjacent the anterior surface of the lens. Here, ring 620 is shown with front surface 622 and rear surface 624. Here, both the front surface and the rear surface of the ring could be considered an interior surface.

The creation of the at least one internal surface can increase or decrease the refractive index of the overall lens. In some embodiments, the optical power of the lens is adjusted by more than zero diopters and up to 2 diopters. At this level of power change, the number of unique molds that have to be built to form contact lenses can be reduced and replaced by modifiable replacements with a cheaper process, thereby reducing a recurring manufacturing cost for the industry. For more power adjustment, more closely spaced rings would be desirable. Conversely, for less power, a wider spacing may be utilized.

The interior surface(s) of the lenses of the present disclosure can be “written” using a laser writing system that includes a laser and an objective lens. The objective lens generally has a numerical aperture greater than 0.5. In three dimensional laser writing, high numerical aperture systems creates an intense focal spot, i.e. a voxel. The focal spot bleaches or cures a voxel within the lens. The voxel typically has dimensions of from about 0.5 microns to about 2 microns in length, width, and height. Because the exposure energy from the laser only reaches a high intensity at the exact focal point of the objective system, the subsequent material changes are confined to the voxel, with little to none of the material above and below the voxel being exposed to sufficient energy to alter its refractive index. Again, the exterior shape of the lens is not changed by the methods of the present disclosure. The anterior surface and the exterior surface of the lens are not changed.

Desirably, short-wavelength lasers are used. In particular embodiments, the laser is a HeCd laser or a diode laser. In specific embodiments, the HeCd laser is a 325 nm HeCd laser. The diode laser may be a 266 nm diode laser. These lasers provide small focal volumes, and thus lead to sharper features in the interior of the lens and may be more efficient at producing interior surface(s) which direct light passing through the lens to a desired focal spot. The laser may be a continuous wave laser (CWL). The power stability of the laser, the mode quality (TEMOO is preferred, with M-parameter <1.3), pointing stability error (as small as possible is preferred), and mode hopping characteristics are important parameters in creating small focal volumes with highly repeatable performance during the time required to write the lens.

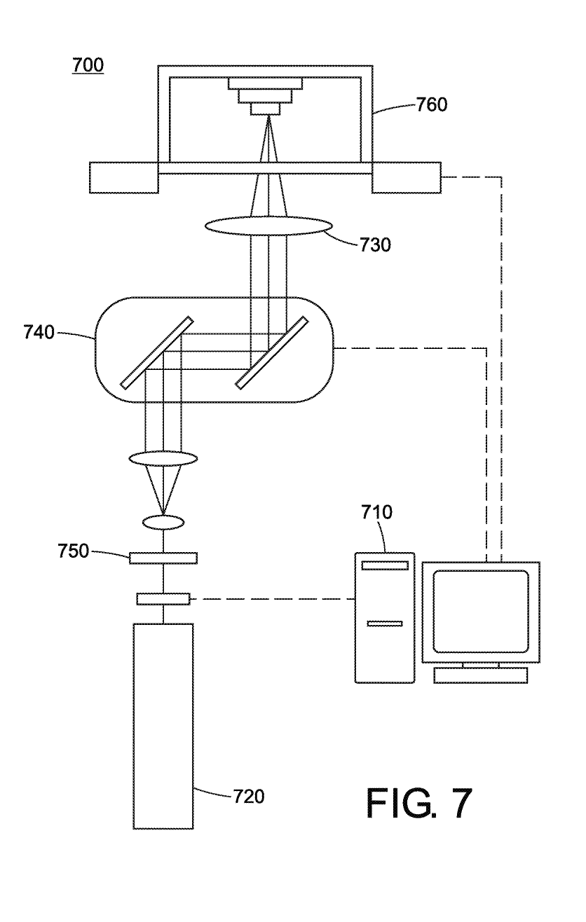

FIG. 7 schematically illustrates a laser writing system 700 which may be used to perform the methods of the present disclosure. The system 700 includes a computer 710, a laser 720, an objective lens 730, a galvano scanner 740, an ND filter 750, and an XYZ stage 760. The computer 710 is used to control the equipment. The laser 720 provides the energy needed to change the refractive index of the irradiated portions of the lens. The objective lens 730 focuses the energy of the laser into a voxel. The galvano scanner 740 can adjust the direction of the laser beam as needed to direct the laser light to the desired location through the objective lens. The neutral density (ND) filter 750 modifies the intensity of the laser light. The lens to be modified is mounted on the XYZ stage 760, which permits the lens to be moved in any direction as needed relative to the objective lens 730.

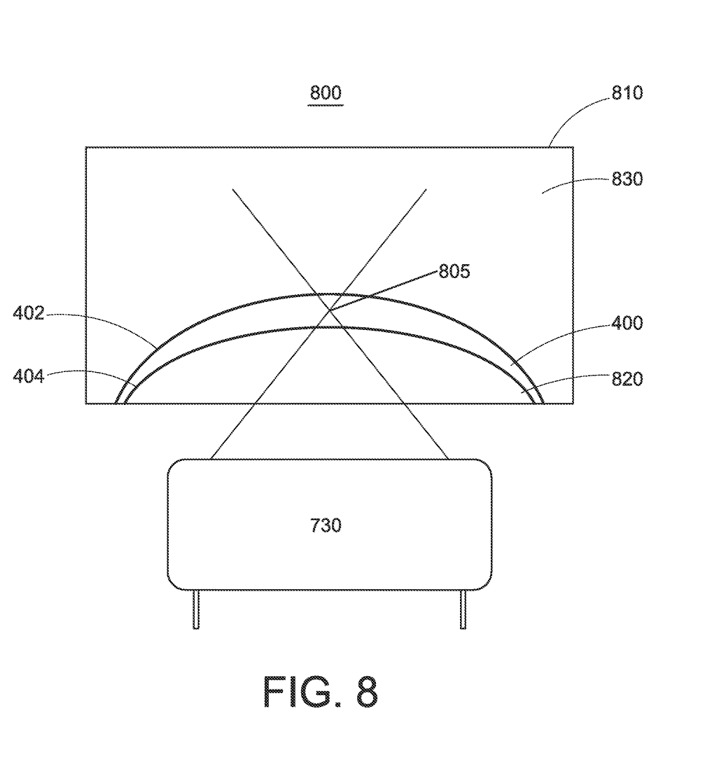

FIG. 8 is a magnified view of the XYZ stage. The stage 800 includes a mandrel 820 upon which the lens 400 is placed to maintain its shape. The mandrel 820 contacts the posterior surface 404 of the lens. A housing 810 surrounds the mandrel 820. The anterior surface 402 is coated with a liquid cover solution 830 prior to exposure to radiation. The liquid cover solution can reduce unwanted reflections during exposure. The objective lens 730 focuses the radiation from the laser (not shown) into a microvolume, i.e. a voxel 805. Different voxels within the volume of the lens are selectively irradiated to form the desired interior surface(s) and alter the refractive index of the voxel(s). Benefits of this method include the ability to eliminate the optical influence of the curvatures of the lens from the writing process; and to allow registration to a high degree of accuracy for the system. The mandrel and laser system are aligned once and maintain their relative position during the treatment of multiple lenses. The solution may be an index matched fluid and the mandrel may be made of glass. The combination of these materials can eliminate reflections from the interfaces of the contact lenses, thereby providing a cleaner exposure process during writing.

The original lens is formed from a polymer matrix containing photobleachable chromophores. The chromophores may be present as separate compounds dispersed within the polymer matrix, or as pendant groups on the polymer matrix. Upon exposure to the radiation from the laser, the chromophores within the voxel are photobleached. This alters the refractive index of the polymer matrix in the voxel and creates the interior surface, altering the optical power of the lens. The refractive index may increase or decrease, and decreases in specific embodiments.

Use of the methods described above are specifically contemplated for use with intraocular lenses and with contact lenses. Contact lenses are generally made from biocompatible polymers which do not damage the ocular tissue and ocular fluid during the time of contact. In this regard, it is known that the contact lens must allow oxygen to reach the cornea. Extended periods of oxygen deprivation causes the undesirable growth of blood vessels in the cornea. “Soft” contact lenses conform closely to the shape of the eye, so oxygen cannot easily circumvent the lens. Thus, soft contact lenses must allow oxygen to diffuse through the lens to reach the cornea.

Another ophthalmic compatibility requirement for soft contact lenses is that the lens must not strongly adhere to the eye. The consumer must be able to easily remove the lens from the eye for disinfecting, cleaning, or disposal. However, the lens must also be able to move on the eye in order to encourage tear flow between the lens and the eye. Tear flow between the lens and eye allows for debris, such as foreign particulates or dead epithelial cells, to be swept from beneath the lens and, ultimately, out of the tear fluid. Thus, a contact lens must not adhere to the eye so strongly that adequate movement of the lens on the eye is inhibited.

Suitable polymeric materials for contact lenses are well known in the art. For example, polymers and copolymers based on 2-hydroxyethyl methacrylate (HEMA) are known, as are siloxane-containing polymers that have high oxygen permeability, as well as silicone hydrogels. Any suitable material can be used for the polymer matrix of a contact lens to which the methods described herein can be applied.

In particular embodiments, the chromophore contains a malononitrile moiety. Exemplary chromophores include those of Formulas (I) and (II), which are also known as VC60 and EC24, respectively:

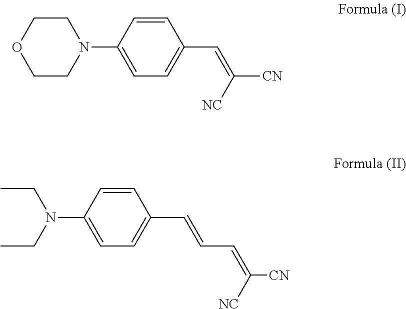

Formula (I) may also be called 4-morpholinobenzylidene malononitrile. Formula (II) may also be called 2-[3-(4-N,N-diethylanilino)propenylidene] malononitrile.

In other embodiments, the chromophore is a stilbene compound of Formula (III):

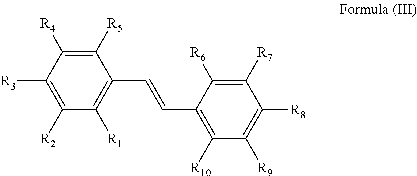

where R₁-R₁₀ are independently selected from hydrogen, alkyl, substituted alkyl, aryl, substituted aryl, —COOH, and —NO₂.

The term “alkyl” as used herein refers to a radical which is composed entirely of carbon atoms and hydrogen atoms which is fully saturated. The alkyl radical may be linear, branched, or cyclic. Linear alkyl radicals generally have the formula —CₙH₂ₙ₊₁.

The term “aryl” refers to an aromatic radical composed of carbon atoms and hydrogen atoms. When aryl is described in connection with a numerical range of carbon atoms, it should not be construed as including substituted aromatic radicals. For example, the phrase “aryl containing from 6 to 10 carbon atoms” should be construed as referring to a phenyl group (6 carbon atoms) or a naphthyl group (10 carbon atoms) only, and should not be construed as including a methylphenyl group (7 carbon atoms). The term “heteroaryl” refers to an aryl radical which is not composed of entirely carbon atoms and hydrogen atoms, but rather also includes one or more heteroatoms. The carbon atoms and the heteroatoms are present in a cyclic ring or backbone of the radical. The heteroatoms are selected from O, S, and N. Exemplary heteroaryl radicals include thienyl and pyridyl.

The term “substituted” refers to at least one hydrogen atom on the named radical being substituted with another functional group selected from halogen, —CN, —NO₂, —COOH, and —SO₃H. An exemplary substituted alkyl group is a perhaloalkyl group, wherein one or more hydrogen atoms in an alkyl group are replaced with halogen atoms, such as fluorine, chlorine, iodine, and bromine. Besides the aforementioned functional groups, an alkyl group may also be substituted with an aryl group. An aryl group may also be substituted with alkyl. Exemplary substituted aryl groups include methylphenyl and trifluoromethylphenyl.

Generally, the substituents R₁-R₁₀ are selected to enhance other properties of the chromophore. For example, R₁, R₅, R₆, or R₁₀ could be selected to be a crosslinkable group, such as a carboxylic acid. The substituents may also be selected as to control the absorption maximum and/or the refractive index of the chromophore, such as trifluoromethyl (to lower the refractive index), or a nitro group (to redshift the absorption maximum). The substituents may also be selected to enhance the photostability of the chromophore. For example, inclusion of a bulky group at the 2 or 2′ position, such as phenyl, inhibits trans-cis isomerization.

In other embodiments, the chromophore is an azobenzene compound of Formula (IV):

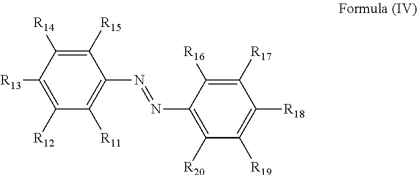

where R₁₀-R₂₀ are independently selected from hydrogen, alkyl, substituted alkyl, aryl, substituted aryl, —COOH, —NO₂, halogen, amino, and substituted amino. Generally, the substituents R₁₀-R₂₀ are selected to enhance other properties of the chromophore.

The term “amino” refers to —NH₂.

Other combinations of polymer matrix and chromophore may also be suitable for the present application.

Aspects of the present disclosure may be further understood by referring to the following example. The example is merely for further describing various aspects of the devices and methods of the present disclosure and is not intended to be limiting embodiments thereof.

### EXAMPLE

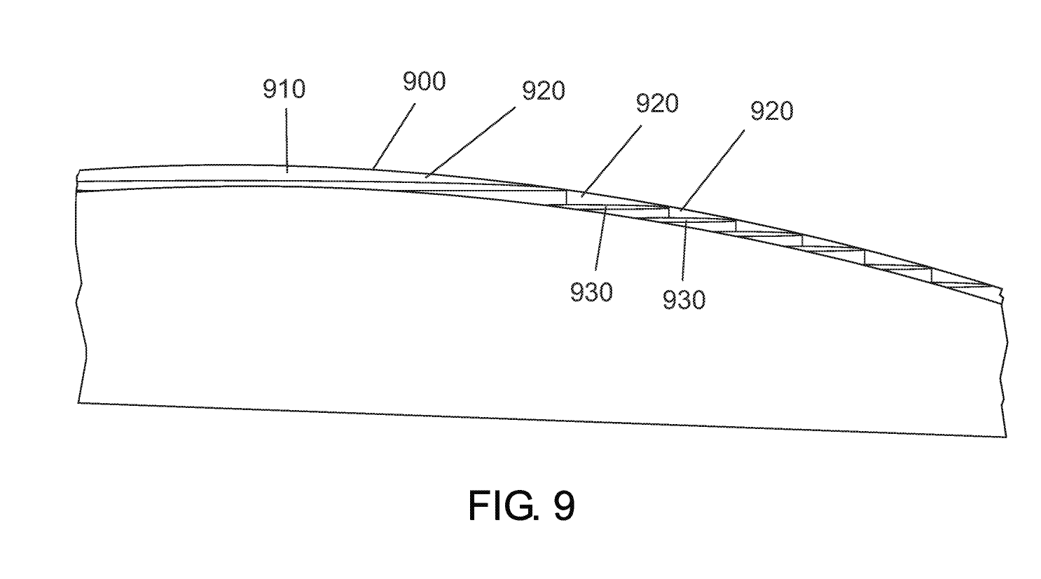

A method for achieving a 2 diopter change in a contact lens was modeled using modeling software from Photon Engineering called FRED. A 1.4 refractive index lens was used for the nominal contact lens material and was written to change the refractive index to 1.385 in modified lens sections. One wavelength was used in the analysis. FIG. 9 illustrates a cutaway view of the lens 900 which includes the biconvex lends 910, higher refractive index portions 920 and lower refractive index portions 930. Multiple interior surfaces are present at the interfaces of the higher and lower index portions. The higher refractive index portions here have the nominal contact lens value, while the lower refractive index portions have been written.

The creation of interior surfaces according to the methods of the present disclosure can be used to correct aberrations and/or to adjust the overall power of the lens. The methods may permit the reduction in the number of discrete lens molds that have to be made on a recurring schedule by the contact lens industry. The reduction would thereby reduce the costs of covering the entire eye correction market with custom hardware by using the disclosed methods and capability.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A method of adjusting the optical power of a lens, comprising:
exposing an interior volume of the lens to radiation, creating at least one interior surface within the lens;
wherein the radiation alters the refractive index of the interior volume, thereby adjusting the optical power of the lens.

2. The method of claim 1, wherein the lens is a contact lens.

3. The method of claim 1, wherein a plurality of refractive surfaces are created.

4. The method of claim 3, wherein the interior volume is in the form of a central disk and at least one sequential ring.

5. The method of claim 4, wherein the central disk has a diameter of about 2 mm.

6. The method of claim 4, wherein the central disk has a thickness of from 0.01 mm to 0.7 mm.

7. The method of claim 4, wherein the central disk is in the form of a biconvex lens.

8. The method of claim 4, wherein a rear surface of the at least one sequential ring is adjacent an anterior surface of the lens.

9. The method of claim 1, wherein the optical power of the lens is adjusted by up to 2 diopters.

10. The method of claim 1, wherein the lens is exposed to radiation using a laser and an objective lens that has a numerical aperture greater than 0.5.

11. The method of claim 10, wherein the laser is a HeCd laser or a diode laser.

12. The method of claim 10, wherein the laser is a continuous wave laser.

13. The method of claim 1, further comprising placing a posterior surface of the lens on a mandrel and coating the lens with a liquid cover solution prior to exposing the lens to radiation.

14. The method of claim 1, wherein an exterior shape of the lens is not changed.

15. The method of claim 1, wherein the lens is formed from a polymer matrix including photobleachable chromophores.

16. The method of claim 15, wherein the photobleachable chromophores are dispersed within the polymer matrix, or are present as pendant groups on the polymer matrix.

17. The method of claim 1, wherein the non-exposed volume of the lens has a first refractive index, and the exposed volume of the lens has a second refractive index which is different.
